(19) United States
(12) Patent Application Publication
(10) Pub. No.: US 2026/0148011 A1
(43) Pub. Date: May 28, 2026

(54) AUTOMATED DESIGN OF VARIATIONAL REFERENCED PATTERNS OF INFORMATION FOR ALIGNMENT OF GENERATIVE PROCESSES WITH HUMAN PREFERENCES

(71) Applicant: Dell Products L.P., Round Rock, TX (US)

(72) Inventors: Werner Spolidoro Freund, Rio de Janeiro (BR); Herberth Birck Fröhlich, Florianópolis (BR); Marcus Vinicius Libardi Pazini, Caxias do Sul (BR)

(21) Appl. No.: 18/962,134

(22) Filed: Nov. 27, 2024

(51) Int. Cl. G06F 40/40

(52) U.S. Cl. CPC G06F 40/40

(57) ABSTRACT

Aligning generative systems and processes to user preferences is disclosed. A curated dataset that include question/answer (QA) pairs is generated from a source. The QA pairs include a question, a squashing instruction, and a referenced pattern of information (RPI). The QA pairs, when curated, reflect final user preferences. The alignment of a generative system to the final user preferences can be measured and/or tracked using the curated dataset in a repeatable and automated verification operation. The answers generated by the generative system to the QA pairs can be compared with the RPIs to determine a correctness of the answer in the verification method. A cumulative score for all of the QA pairs represents an alignment of the generative system to the final user preferences. Variational RPIs may be generated by diversifying original RPIs.

### TECHNOLOGICAL FIELD OF THE DISCLOSURE

Embodiments disclosed herein generally relate to aligning generative systems. More particularly, at least some embodiments relate to systems, hardware, software, computer-readable media, and methods for aligning generative machine learning/artificial intelligence with user preferences by generating and using variational or diversified patterns of information.

### BACKGROUND

Retrieval augmented generation (RAG), a form of a generative system, typically includes a retriever and a generator (e.g., a large language model (LLM)). The RAG system, when presented with a question (or query), uses the question to identify data from knowledge sources. The data identified and retrieved by the retriever is used as context for a prompt submitted to the LLM. In a RAG system, the LLM may be constrained such that answer to the query should not deviate from the content given as input. RAG systems helps ensure that the outputs of LLMs are reliable, up-to-date, and factual.

Current implementations of RAG systems typically break documents that populate a set of databases into chunks of raw text, which are then used as sources for question-and-answering and other applications. More specifically, these chunks are transformed into a vectorial representation (an embedding) with a language model, stored into a vector database and indexed. The language model used for embedding the chunks may be the same language model used to answer user queries. Typically, however, a lighter model (with fewer parameters) is employed to generate the embeddings. The chunks are stored with metadata indicating the original source document and/or other information.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of generating a curated dataset that includes question/answer (QA) pairs that each include a question, a squashed instruction, and an answer or RPI;

FIG. 2 discloses additional aspects of generating a curated dataset of RPIs and illustrates a knowledge distillation phase and a feedback phase;

FIG. 3 discloses aspects of a user interface presented during the feedback phase;

FIG. 4 discloses aspects of an automatic verification operation performed on a generative system using the curated dataset;

FIG. 5 discloses aspects of generating a curated dataset of variational RPIs;

FIGS. 6A-6E disclose more specific aspects of generating a curated dataset of variational RPIs;

FIGS. 7A-7C disclose an example of curating variational RPIs from previously curated RPIs; and

FIG. 8 discloses aspects of a computing device, system, or entity.

### DETAILED DESCRIPTION OF SOME EXAMPLE EMBODIMENTS

Embodiments disclosed herein generally relate to aligning generative systems and processes. More particularly, at least some embodiments relate to systems, hardware, software, computer-readable media, and methods for aligning generative systems and processes with user preferences and to evaluating generative systems and processes to measure alignment thereof with the user preferences.

Embodiments of the invention are discussed in the context of retrieval augmented generation (RAG) systems and question/answer or extraction applications. Embodiments of the invention, however, are not limited thereto and may be applied with generative systems generally and in the context of other applications, including LLM-based applications.

RAG systems are systems that enhance the ability of navigating, by way of example only, enterprise-level content. RAG systems are able to add knowledge to existing generative systems without retraining the generative systems. Upon receiving a question, relevant information is searched and retrieved from indexed databases (information retrieval), and the retrieved information is then passed to a Large Language Model (LLM) to generate an answer (content generation). This approach allows LLM responses to account for fresh, up-to-date, and/or confidential information.

When a user submits a question to the RAG system, the submitted question is first embedded with the same language model used to embed the chunks. The embeddings are used to search for the most similar chunks in the vector database. Similarity in the vector space is typically computed with some distance function such as Euclidean distance, cosine distance, or the like. This process is referred to as semantic search because the embeddings encode semantic meaning.

From the top k most similar chunks, the associated documents (and/or any additional metadata) are retrieved by the retriever. These, in turn, are used to assemble the input and provide context for prompting the LLM. Typically, the input follows a template having some natural language instruction for the LLM, the question to be answered, and the document contents to be summarized or used.

RAG systems may vary, by way of example, in the choice of the language model for the embeddings, the chunking strategy used for source documents, the types of metadata associated with the chunks, how the documents associated with the chunks are accessed and processed, how the LLM input is assembled, and in the choice of the LLM itself.

Measuring the efficiency of RAG systems, however, is challenging. More specifically, RAG systems often include two main modules as previously stated: a retriever and a generator. The retriever retrieves documents based on the question and the generator generates a response based on the question and the retrieved documents. Achieving scalability and aligned efficiency measurements is difficult.

With regard to scalability, standard pattern matching approaches like ROUGE (Recall-Oriented Understudy for Gisting Evaluation) or BLEU (Bilingual Evaluation Understudy) rapidly falter in providing a reliable measure of a system's efficiency due to a phenomenon known as the curse of dimensionality. More specifically, these approaches fail to explore manifolds (connected regions with high density that can be described in lower dimensional space) in the output space. Consequently, these approaches of necessity span over all possible answer variations. Because the number of variations grows exponentially with output space dimensions, these approaches cannot scale to high dimensional spaces such as those available in typical computational representations of text information.

Scalability is relevant to efficiency measurement at least because scalability allows a holistic understanding of system behavior and enables observability over blind spots. The ability to understand system behavior enables modifications impacting system behavior to be traced, for example when performing continuous integration/continuous deployment (CI/CD) tests. Unfortunately, this is lacking in conventional systems.

Approaches to addressing scalability issues have various limitations. One approach to the scalability problem is to collect human feedback. Human feedback is typically obtained by comparing outputs and picking the preferred solution. However, this type of human feedback is required every time the system is modified. Allocating several business experts to perform manual evaluation at every improvement cycle is not a viable solution due to its high cost and latency, which suggests a clear need for a more efficient solution.

Another approach to scalability concerns is to employ LLMs and other model-based evaluation methods to leverage on learned manifolds to address the exponential growth in the number of possible correct answers. This approach leads to alignment issues between the answer generated by the LLM and user preferences.

Measurements of system efficiency should be reliable and provide guidance on how to improve the RAG system with regard to user preferences. Conventional automated methods rely completely on LLMs to determine answer alignment. The reasoning behind this approach builds upon the alignment of LLMs with human preferences, which suggests that evaluations should also be aligned.

For example, some models generate measurements that are aligned to general audience preferences. These assessments, however, are only focused on general preferences and aligning the models to different preferences is challenging. More specifically, when focusing on information silos, the standard behavior of RAG systems is often inadequate because the behavior is not aligned to specific user preferences.

For example, most general-purpose RAG systems are designed to perform abstraction upon retrieved content (because general-purpose LLMs employed in generators are optimized this way). When performing abstractions, the retrieved content is manipulated to a new representation that is deemed more effective in each context (such as reasoning or extracting novel insights).

However, other users (e.g., business users) using RAG systems to break information silos may be interested in extractive capabilities, such that relevant and correct information is provided nearly as is to the user. Business content, for example, already contains the result of all reasoning in the document itself (e.g., competitive intelligence, strengths, produce/service limitations) and does not require further manipulation. In addition, business users are accountable for their choices and mostly prefer to perform reasoning for themselves rather than relying on black-box mechanisms subject to errors of various natures that are often difficult to be detected (e.g., hallucinations). As a result, the use of general-purpose LLMs for evaluation purposes does not align with business user preferences because the models are being optimized for a different purpose.

Aligning RAG systems or LLMs to novel or different preferences is a complex, time consuming, and financially demanding process. Using LLMs for automated efficiency evaluation is often unsatisfactory and is subject to uncontrolled and unknown systematic impacts due to imperfect alignment.

As previously stated, deriving reliable end-to-end efficiency measurements for RAG systems or RAG-based applications is challenging. Efficiency measurements includes obtaining quality measurements for generated responses, including the correctness of an answer or response that accounts for answer alignment with a reference or that accounts for specific user preferences. This is relevant for understanding system behavior, implementing Continuous Integration (CI)/Continuous Deployment (CD) tests and making informed decisions for system development. Embodiments of the invention thus relate to providing reliable end-to-end correctness and/or efficiency measurements for RAG systems and RAG-based applications.

Reliable correctness measurements are provided in the context of a scalable solution in embodiments of the invention. By way of example, a scalable solution places statistical pressure towards good solutions as the system evolves. This allows the number of evaluations to grow as computational power becomes available. A scalable solution can be repeated and may automatically compute efficiency values or measurements as needed. This allows system progress to be traced across system modifications. In embodiments of the invention, computing efficiency values is not a demanding process and can be achieved with low latency. For example, efficiency measurements for a RAG system may be computed. After implementing changes to the RAG system, the efficiency measurements may be obtained or computed again. Repeated efficiency measurements may illustrate progress in aligning the RAG system with final user preferences rather than conventional or general purpose preferences in one example.

Embodiments of the invention provide reliable correctness or efficiency measurements that are aligned with user preferences. In one example, the correctness measurements provide insight as to how well the RAG system is aligning with specific or final user preferences. Embodiments of the invention do not rely on black box processes for determining computing efficiency and provide a way to control systematic effects in the evaluation process. Thus, embodiments of the invention allow and enable modifications to a RAG system such that final or desired user preferences are included or reflected in the modifications and outputs or answers generated by the RAG system.

Embodiments of the invention relate to a scalable system that is configured to place statistical pressure towards good or desired solutions as the system evolves such that the solutions are aligned with user preferences. This makes the system capable of growing the number of evaluations as more computational power becomes available. Scalability ensures the efficiency values can be computed as needed and provides a mechanism to trace system progress during modifications.

In addition to scalability, embodiments of the invention provide or generate a correctness efficiency measure that measures how the generative system is aligned with final user preferences. Embodiments of the invention relate to end-to-end reliable and scalable evaluation of LLM and/or RAG systems to measure or determine alignment thereof with final user preferences.

This is achieved, in part, by generating and curating a dataset that allows automatic efficiency and/or correctness computations/measurements to be performed efficiently and/or repeatedly.

In one example, referenced patterns of information (RPIs) are generated by distilling the knowledge of an LLM using models, such as aparametric models. Aparametric models are configured to capture possible answers. In one example, an RPI identifies a relevant and correct information aspect to be output by the RAG system for a particular input or question, or identifies that the RAG system is abstaining to provide an answer to the question. In one example, RPIs are regular expressions. An example RPI dedicated to identifying an affirmative answer could be: ‘\b(yes | certainly)\b’.

RPIs may further be represented as cRPIs (correct RPIs), aRPIs (abstain RPIs), and v-CRPIs or vRPIs (variational cRPIs). Other types of RPIs may be used. Different types of RPIs may be referred to generally as RPIs herein.

RPIs may be combined with or used in conjunction with a squashing instruction (SQI). More specifically, to ensure that RPIs are efficient in capturing answer variations, an automated process of generating questions and answers in a RAG system may include a squashing instruction configured to minimize or reduce the span of valid answers, which places statistical pressure on the processes. SQIs can be defined to maximize alignment with final user preferences. However, general purpose SQIs that can be broadly used for alignment of RAG systems with business preferences are also disclosed. An input/question that includes an SQI is an example of a squashed question (SQT).

Embodiments of the invention may also incorporate a human in the loop or human feedback. For example, a question and answer pair (QA pair) containing an SQT and RPI(s) may be subject to a curation process or operation. The curation process, which may alternatively be performed using machine learning, allows errors in the distillation process to be fixed or corrected to ensure that final user preferences are enforced or such that the RAG system is aligned with the final user preferences. Using a user interface, corrections/recommendations to the QA pairs. In other words, the QA pairs can be added, changed, deleted, or the like such that the RAG system aligns with final user preferences.

The curation process also enables reliable efficiency measurements to be obtained, in contrast to LLM-based verification operations. In one example, the knowledge distillation and feedback operation may be performed a single time. In addition, the human feedback is scalable.

A curated SQT together with corresponding RPIs, provides a way to automatically measure alignment of a response or answer generated by a RAG system to specific or final user preferences. In another example, the sources retrieved by the RAG retriever can be compared with the original sources of the LLM. This enables the efficiency of the retriever to be determined or measured. Embodiments of the invention provide computationally efficient and repeatable verification in the context of aligning a RAG system with final user preferences. The efficiency of the retriever and/or the generator or of the RAG system collectively can be determined.

Distilling knowledge to RPIs that include a single pattern (e.g., singleton cRPIs) provide resiliency in capturing answer or response variations. However, these variations may result in efficiency gaps. In addition, an answer may contain inconsistencies that invalidate the presence of another RPI. For example, a correct answer may be invalidated such as in “yes, but no” or “it contains 1, 2, 4, 6 and 8 CPUS”. Embodiments of the invention, in addition to generating variational RPIs to further avoid systematic errors in efficiency measurements.

For example, embodiments of the invention allow low entropy variations around the manifolds originating for SQTs and avoid false negatives. Embodiments of the invention also allow false positives caused by the present of diverging information to be avoided.

More generally, vRPIs help avoid systematic errors in efficiency while maintaining model interpretability and correction toward final user preferences.

Generally, verification (an example of measuring correctness or efficiency) is performed using the QA pairs (e.g., (question, instruction, answer) or (squashed question, RPI)) by receiving an SQT as input into a RAG system and allowing the RAG system to generate an answer. The correctness of the answer can be assessed using the RPI in the QA pair. More specifically, a fully correct answer includes all aspects indicated in the corresponding RPI or RPIs associated with the SQT. If only some of the RPIs are represented in the answer, the correctness may be reduced or scaled. In this manner, the answers generated in response to the QA pairs can be scored (e.g., penalty, reward). A cumulative or total score may be generated by summing the individual scores of the QA pairs. The cumulative score is an example of a measurement of how the RAG system is aligned with user preferences, which are reflected in the RPIs. CRPIs and vRPIs improve the ability to measure the efficiencies of RAG systems and in particular of efficiencies with respect to alignment considerations.

More specifically, the automated verification method uses the answer generated by the RAG system in response to an SQT and the RPIs to generate or assign information bits that identify whether the output or response matched the RPIs. The information bits allows a statistical score to be generated based on whether the answer matched an RPI (or RPIs). Scores from multiple QA pairs can be aggregated when measuring or determining correctness or efficiency. This allows key performance indicators (KPIs) and other measurements to be determined or generated.

In one example, an end-to-end evaluation or verification method is disclosed. The method introduces RPIs and SQTs that allow system efficiencies to be automatically determined or measured. This is an improvement over black box approaches such as LLMs and standard matching approaches that cannot provide reliable measurements (due in part to the curse of dimensionality).

RPIs and SQTs (QA pairs) can be generated or derived through the distillation of LLM knowledge, resulting in a scalable approach. For example, additional QA pairs can be generated and/or used as more compute power becomes available. RPIs and SQTs can be aligned with final user preferences without training an LLM, thus directly obtaining a cheap reward function to guide the system development. RPIs provide an interpretable and simple way to represent what is relevant and required for an answer to be considered fully correct. The alignment evaluation can be repeated as many times as needed. The reward function can be easily adjusted whenever required by directly modifying RPIs and/or SQTs in the QA pairs. Thus, systematic effects during evaluation of the RAG system can be controlled by collecting human feedback during or after the generation of RPIs and SQTs. In one example, human feedback needs to be collected only once, but may be updated if desired. This is an improvement over other approaches that require feedback after every modification.

Embodiments of the invention further expand the ability of RPIs to cope with different squashing instructions and diversification strategies. For example, assuming that a curated set of QA pairs has been generated, a variational dataset of curated QA pairs may be generated. In one example, a variational RPI includes a correct RPI and variations of the correct RPI.

In a first stage of generating a curated dataset of variational QA pairs, a diversification strategy may be defined for each unique SQI in the original curated dataset of QA pairs. Generally, the diversification strategy maps singleton RPIs to variational RPIs. Example diversification strategies include LLM diversification, hard coded diversification, and/or custom-defined diversification. Custom strategies can be defined, for example, by defining custom transformation prompts to be employed by LLMs. Multiple diversification strategies can be applied at once.

More specifically, the first stage starts with the automatic extraction of every different or unique SQI that is within the original dataset of QA pairs. In one example, each SQI type is prompted to a user (e.g., a subject matter expert (SME)) so that one or more strategies can be appended to each of the unique SQIs. This generates a dataset of strategy guidelines that includes a mapping of SQIs to strategies.

When generating the variational QA pairs, a QA pair is retrieved, the SQI is identified, and the strategies mapped to the SQI are executed. After executing strategies, a cleaning operation is performed to exclude redundant or nearly redundant RPIs. The nearness of an RPI may be based on a measurement metric. After cleaning, each RPI is subjected to a divergence check to remove ambiguities. The output these processes is a curated dataset of variational RPIs. Thus, correct RPIs (cRPIs) are converted to v-cRPIs.

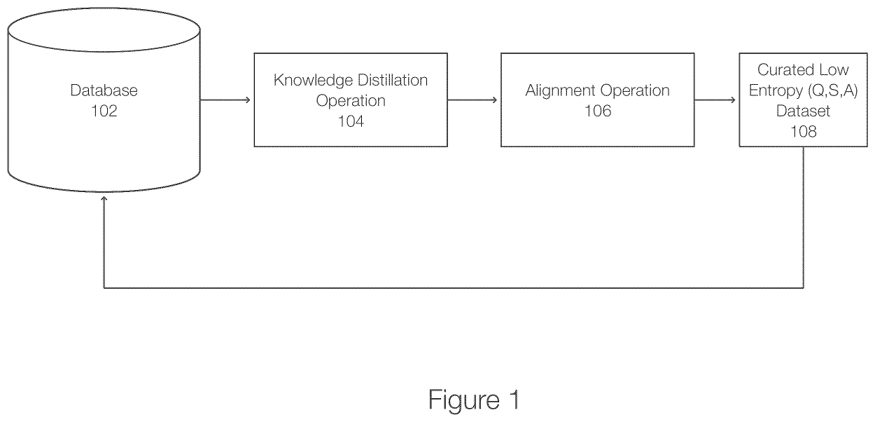

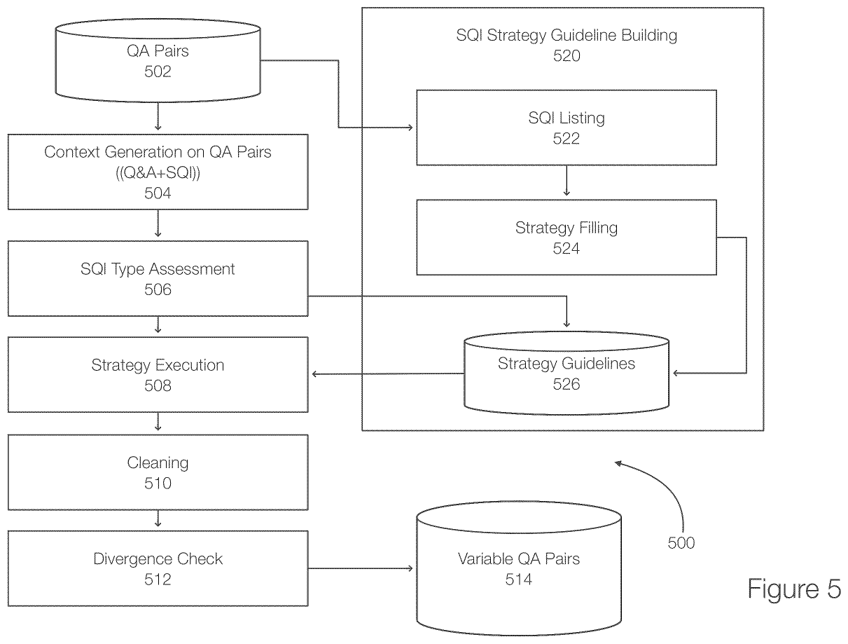

Embodiments of the invention provide the ability to automatically distillate variational or variational RPIs, allowing RAG systems to deal with low entropy variations in output manifolds. The process of distilling variational RPIs maintains interpretability and efficiency when collecting human feedback for system alignment. Further, inconsistency checks (or efficiency measurements) may be generated automatically based on the variational RPIs, which are included in the QA pairs of the curated dataset of variational RPIs. FIGS. 1-4 relate generally to generating RPIs and performing verification operations. FIGS. 5A-7C relate to generating a curated set of variational RPIs from the curated set of RPIs (CRPIs and/or aRPIs) disclosed in FIGS. 1-4.

FIG. 1 discloses aspects of generating and/or curating a low entropy dataset, which may be configured for use in measuring efficiencies and/or alignment of a RAG system to final user preferences. FIG. 1 illustrates a database 102 that may include, by way of example, source documents for a generative system, such as an RAG system. Generating or curating the low entropy dataset includes performing a knowledge distillation operation 104 on the database 102 or sources stored therein. The knowledge distillation operation 104 is performed to generate question/input and answer/output pairs or QA pairs. The QA pairs are generated, in one example, by instructing an LLM to generate questions and answers from the database 102 (or portions or sources therein).

Next, an alignment operation 106 is performed to align the QA pairs with final user preferences. This may be performed without relying on LLMs in one example. This results in a curated low entropy dataset 108, which may be stored in the database 102 or in a separate storage. The dataset 108 may be referred to by way of example as a dataset of QA pairs or a dataset of RPIs.

More specifically, the knowledge distillation operation 104 distills LLM knowledge (e.g., the database 102) onto RPIs and/or introduces squashing instructions to the questions/inputs. The curated dataset 108 is represented by a form (Q,S,A), where Q is the question/input, S is the squashing instruction, and A is an RPI (or answer) in one example. In another example, the QA pairs in the curated dataset 108 may be represented as (SQT, RPI), where the SQT includes a question and a squashing instruction.

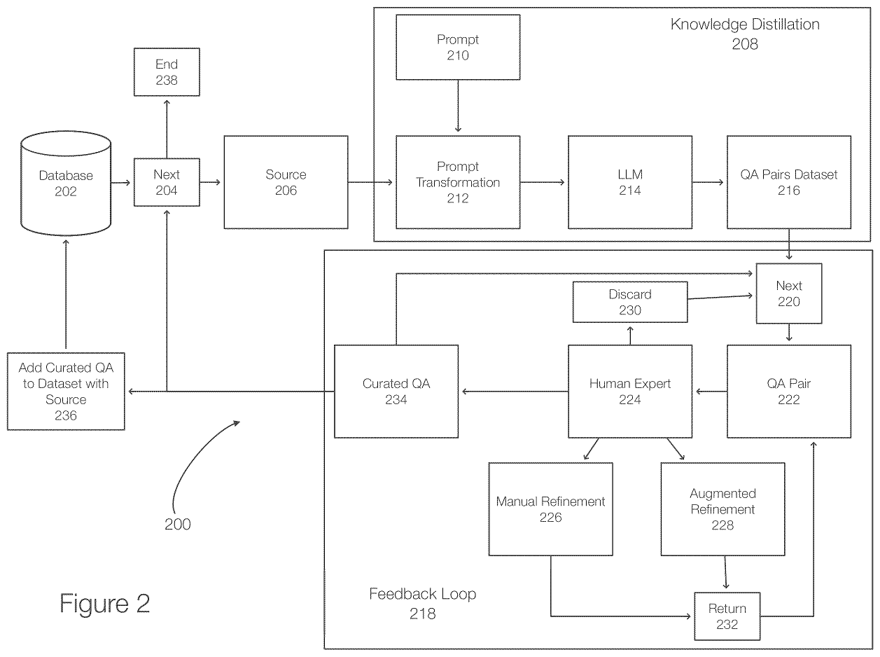

FIG. 2 discloses additional aspects of generating and/or curating a dataset. FIG. 2 illustrates a database 202 (e.g., knowledge added to a RAG system). Sources, such as the source 206 (e.g., a document or set of documents) are retrieved from the database 202 until all sources have been processed in the method 200 in one example. The next 204 block illustrates a decision block that allows the method 200 to iterate through the documents in the database 202. When all documents have been processed and the curated QA dataset is generated, the method 200 may end 238.

Alternatively, specific sources or documents may be processed. In one example, knowledge being added to an LLM (e.g., enterprise or private sources) are processed by the method 200.

The method 200 focuses on a source 206 or document. In this example, knowledge distillation 208 is performed on the source 206. Knowledge distillation 208 may be configured to generate QA pairs that may include SQTs and RPIs.

LLMs, such as the LLM 214, may be configured to generate QA pairs from the source 206. In this example, the prompt 210 (e.g., generate QA pairs from the source 206) is transformed (prompt transformation 212) such that the QA pairs being generated include SQIs and RPIs. In one example, the prompt transformation 212 may include a few shot approach, but embodiments are not limited thereto.

Rather than simply causing the LLM 214 to generate a reference answer to a generated question, the LLM 214 is employed to distillate its knowledge to aparametric models of possible answer patters or RPIs. A single RPI may be a template of pattern variations for the same reference data. In one example, regular expressions (regexp) are used to generate the RPIs.

A correct RPI (cRPI) identifies a relevant and correct information aspect to be output by a RAG system for a particular input or question. Because an answer can require multiple relevant and correct information aspects, a question may map to multiple cRPIs, one for each aspect required for the answer to be considered fully correct and relevant.

In one example, the cRPI provides a way to evaluate a quality dimension such as faithfulness when the RAG system has access to the original source. Faithfulness measures or reflects whether the generative system provides answers that are grounded on the information that has been retrieved.

An abstain RPI (aRPI) indicates that the RAG system is abstaining to provide an actual answer to the input question. In one example, an aRPI is not associated with questions, but identify system behaviors when abstaining to provide an actual output/answer to a given input/question. As a result, aRPIs are typically derived per LLM.

RPIs, in one example, are shallow aparametric models that are derived or determined by distilling LLM knowledge. This provides some benefits in terms of facing the curse of dimensionality with respect to standard parametric pattern matching approaches (like ROUGE or BLEU that are based on n-grams with a fixed number of possible patterns). The nature of ROUGE and BLEU hinders their ability to cover the full span of possible answers.

To address the curse of dimensionality, embodiments of the invention request the LLM to introduce an squashing instruction with the question/input. The role of the instruction is to collapse the output distribution towards a limited number of valid variations of correct answers. Instructions that collapse of output distributions of an LLM are examples of SQIs. From an information theory perspective, the entropy of the distribution of valid answers is reduced and is concentrated around of a few possible representations that are captured using cRPIs.

SQIs can be aligned to tasks of interest of the final user. As a result, generative processes that disregard squashing instruction specifications are violating use cases and, as a result, are not performing as intended. SQIs help ensure that the subset of output space under evaluation is of interest to the application/user and serves as a proxy for performing informed decisions for system optimization and alignment with final user preferences.

In the context of generating QA pairs, SQIs may be general or specific. An example of a general purpose SQI is “respond with an excerpt from the available context.” SQIs may thus focus on relevancy aspects by evaluating whether a generative system can extract all pieces of information deemed relevant for a given input.

Another SQI may be to “respond with a simply yes or no”. This type of SQI may be tied to evaluating particular properties of the generative system. This SQI allows system capability to be measured with respect to polarity (e.g., affirmative/negative). For example, this type of SQI may help determine whether the generative system can consult information in business documents without having to perform any abstraction and provide an affirmative or negative answer.

FIG. 2 this illustrates that QA pairs 216 are generated and that each QA pair includes a question, a squashing instruction, and an answer (Q,S,A). As previously stated, the question and squashing instruction may be represented as a SQT and the answer may be represented as an RPI.

A feedback loop 218 is performed on the QA Pairs 216 when the curated dataset is being generated. In this example, the feedback loop 218 is enhanced with human feedback that is provided by a human expert 224 (or other user). In this example, the next 220 QA pair is retrieved from the dataset 216 and processed in the feedback loop 218.

FIG. 2 thus illustrates an example QA pair 222 in the feedback loop 218. In this example, the QA pair 222 may be subject to one or more flows, which are illustrated by way of example and not limitation. The QA Pair 222 may follow a discard flow. If the QA pair 222 follows the discard flow, the QA pair 222 may be reviewed and discarded 230 for various reasons, such as an incorrect answer, not sufficiently correct answer, or the like. Once a QA pair is discarded, the QA pair may not be considered further and the feedback loop 218 proceeds to the next QA pair in the QA pairs dataset 216.

A refinement flow allows modifications to be provided to better capture relevant and correct aspects required for an answer to be correct. The refinement flow may include a manual refinement 226 in which the human expert 224 provides additional aspects to the QA pair 222. In augmented refinement 228, an LLM may be used to augment the QA pair 222.

The refinement flow may return the QA pairs for further processing or further human review 224.

In an accept flow, the curation of the QA pair 222 is completed and the human expert 224 is satisfied with the content of the QA pair 222. This allows the QA pair 222 to be added to the curated dataset of QA pairs.

When the QA pair 222 is curated, the curated QA pair is added 236 to the database 202, which is an example of a curated dataset or QA pairs (or RPIs). The source may also be identified for the QA pairs included in the curated dataset.

As illustrated, the feedback loop 218 is performed to capture what is required for an answer to be aligned with final user preferences. The feedback loop 218 augments the distillation of the source 206 performed by the LLM 214 to generate cRPIs, which allow relevant and correct answers to be described. The curated dataset allows evaluations of a RAG system to be performed as many times as required without additional feedback and without user input.

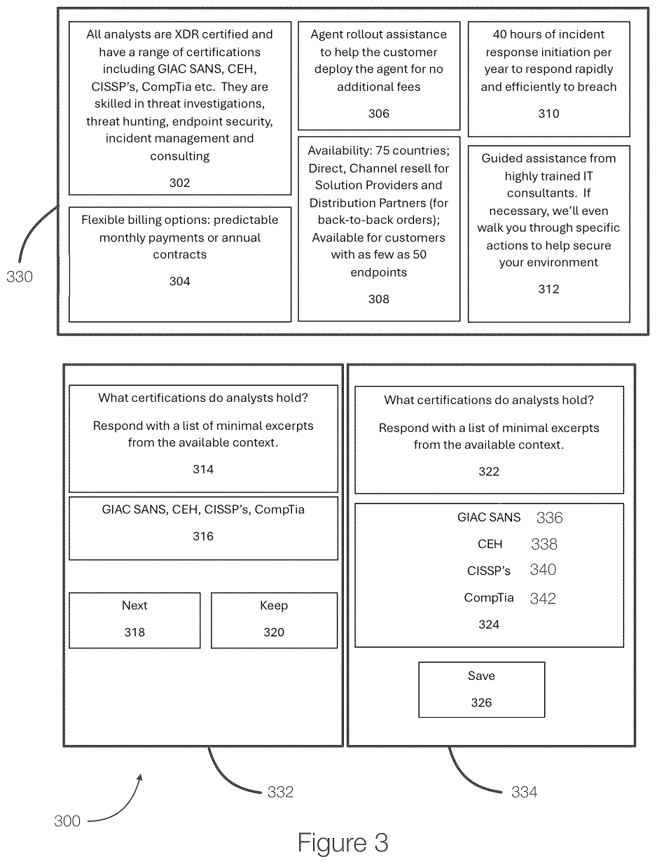

FIG. 3 illustrates an example of a user interface for collecting human feedback. A user interface 300 for facilitating user feedback (e.g., feedback loop 218) is illustrated. FIG. 3 illustrates a source 330 that may include documents 302, 304, 306, 308, 310, and 312. The source 330 may be presented to a human expert in a user interface. The QA pairs generated from the source 330 by distilling the source 330 may be presented in a window 332 of the user interface 300. In this example, a QA pair represented by an SQI 314 (includes question and squashing instruction) and an answer 316 or RPI. The user may work on (edit, alter, change) the QA pair in a window 334. The user may be able to review the sources and change the squashing instruction 322, the RPI 324, or the like. The same QA pair 314 and 316 are illustrated in the window 334 as QA pair 322 and 324.

More specifically, the user may be able to compare the RPI or answer 324 with the sources 330. If changes are required, changes may be made in the window 334 and saved 334. If saved and accepted, this represents an example of the accept flow. Once the QA pair is curated, a user may proceed to a next QA pair via the next button 318. If no changes are needed, the QA pair may be kept 320. The QA pair may also be subject to refinement.

In this example, the answer 324 includes or is associated with 4 RPIs (RPIs 336, 338, 340, and 342). Each RPI represents a correct aspect of the answer 324. Thus, for an answer to this question to be fully correct, all RPIs 336, 338, 340, and 342 should be represented in the answer.

During automated verification (e.g., to measure or determine alignment of the RAG system to final user preferences), the curated dataset of QA pairs may be used. In one example, the questions/instructions are input to a RAG system and the output is compared to the RPI in the curated QA pair. If the RAG system generates an answer that does not include all of answer aspects represented or included in the RPIs, the answer may be incorrect or partially correct and the reward generated during verification reflects the level of correctness.

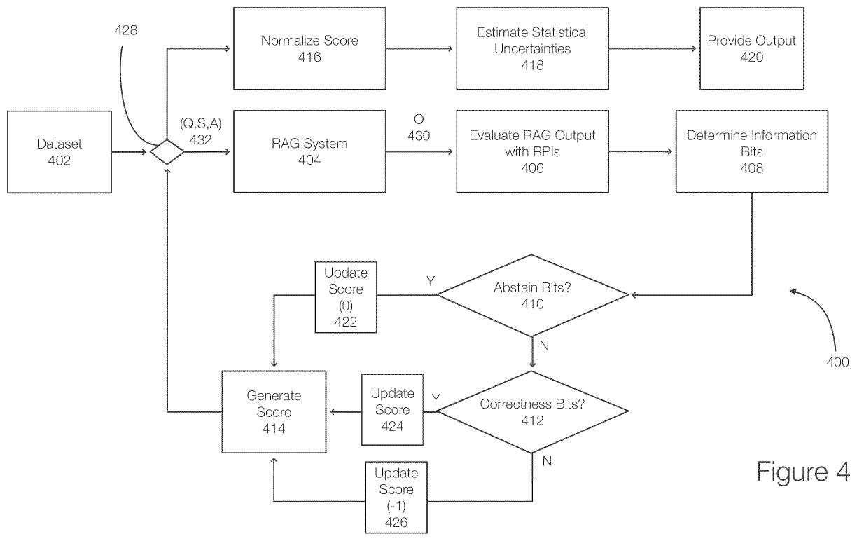

FIG. 4 discloses aspects of an automated verification method for verifying or measuring an efficiency of a generative system, such as a RAG system. FIG. 4 thus illustrates an automated verification method 400. The method 400 may be performed without user input in one example and may be performed repeatedly. Performing the verification method 400 repeatedly over time allows improvements in alignment to user preferences to be tracked as modifications are made to the RAG system.

In FIG. 4, the decision block 428 represents a decision block. For example, after processing a QA pair, another QA pair is retrieved from the dataset 402. This may continue until all QA pairs (or a predetermined number of QA pairs) have been processed in the method 400.

Thus, once a score is generated 414 for a QA pair, the next QA pair is processed. In some examples, QA pairs may be processed in parallel using one or more instances of the method 400.

When all QA pairs have been considered by the method 400, the output 420 (e.g., a final alignment score) is output 420. This may include normalizing 416 the scores based on the number of questions and/or estimating 418 statistical uncertainties.

The method 400 is performed for each QA pair in the dataset 402 and operation of the method is explained for a specific QA pair. In this example, a QA pair 432 (e.g., (Q,S,A) or (SQT,RPI)) is input to a RAG system 404. More specifically, the question (and/or squashing instruction) is input to the RAG system 404. The RAG system 404 generates an answer or output 430 (O). The output 430 of the RAG system 404 is evaluated 406 in light of the RPI(s) of the QA pair 432. Stated differently, the aparametric model(s) or RPIs in the QA pair are applied to or compared with the output 430.

Evaluating the output 430 may include determining information bits 408 for the output 430. The number of information bits for a QA pair may vary and may depend on the number of RPIs associated with the QA pair. Information bits 408 may include correctness bits and abstain bits. In one example, correctness bits are set (e.g., set to 1) if the output 430 matches or complies with an RPI. If the QA pair is mapped to or associated with multiple RPI models, multiple correctness bits may be set. Thus, if the QA pair 432 is associated with four RPIs, there are four correctness bits that may be set based on whether the output 430 includes or complies with the RPIs. For example, and with reference to FIG. 3, the RAG system may return a response of CEH and CISSP's in response to the question “What certifications do analysts hold?” The answer would be partially correct and receive a score of 0.5 (2 out of four) because only 2 of the 4 associated RPIs are present in the answer.

The information bits may also include abstain bits. An abstain bit is set (e.g. set to 1) if the output 430 indicates that the RAG system 404 abstains from answering the question.

Once the information bits are determined 408, the information bits are evaluated and converted to a score. The score represents how aligned the RAG system is to the final user preferences reflected in the curated dataset. In this example, if an abstain bit is present (Y at 410), a score of zero (0) (update score 422) is return for the QA pair 432. When an abstain bit is present, the alignment score is not penalized.

The overall or running score (e.g., a cumulative score for all QA pairs) may also be updated by adding 0 to the score in this example.

If an abstain bit is not present (N at 410), the correctness bits are evaluated. If correctness bits are present (Y at 412), a ratio of retrieved correctness bits to total possible correctness bits for the QA pair 432 is determined and the score is updated 424 with this ratio, thus, the overall alignment score is rewarded based on the correctness of the output 430. This score may also be added to the cumulative score. If correctness bits are not present (N at 412), a score of (−1) is applied and the score is updated 426 as previously described. This penalizes the system for generating an output 430 that is incorrect.

Thus, for each QA pair in the dataset 402, scores are generated 414 for each QA pair and/or for all QA pairs cumulatively. The cumulative or summed score is an example of an alignment measurement or final alignment score.

The final alignment score may be a sum of the QA rewards and penalties normalized 416 by the number of QA pairs in the dataset 402. This is an example of a calibrated KPI (cKPI). The final alignment score or output 420 may be associated with a statistical uncertainty value 418.

### Experiment

In one example, a low entropy dataset was generated from 32 competitive intelligence documents (58 slides). Generating the curated dataset resulted in a total of 91 curated (Q, S, A) QA pairs. The samples were curated by researchers (not final users) to test the system capabilities to align with final user preferences. In this example, the tasks performed by the RAG system are extractive in nature. As a consequence, the curation process is not expected to differ significantly from final user preferences.

From these 91 QA pairs:
Fifty-eight (58) QA pirs use general-purpose instructions dedicated to relevancy aspect (e.g., respond with an excerpt of the available context);
The remaining thirty-three (33) QA pairs cover an answer polarity aspect (e.g., respond with a simple ‘yes’ or ‘no’) on top of inputs consulting information as provided in the documents, where 19 of the QA pairs require affirmative answers and 14 of the QA pairs require negative answers.

This curated dataset was used to verify the efficiency of two RAG systems: (i) a system (JARVIS) composed of complex retrieval and generator modules that inherits all knowledge acquired so far and (ii) a simple generator module with perfect retrieval (Clean Baseline) that is instructed to follow SQIs whenever they are present.

This evaluation identified the following insights.

The first insight is an efficiency bottleneck. A major efficiency bottleneck (approximately a decrease in cKPI of −50±9 percentual points) in JARVIS system occurs due to the injection of noise by the retriever module and a lack of lack of noise robustness in the generator.

This insight, however, is a major improvement with respect to other strategies. Previous methods based on manual evaluation did not provide a way to understand major system bottlenecks. Automated methods failed to provide measurements that aligned with business requirements. This insight allows modifications to be made. Efficiency can be measured using the same curated dataset after making the modifications to the RAG system.

This experiment also demonstrated a systemic impact of a squashing instruction. JARVIS behaved worse when an SQI is introduced in the input with respect to a question without the SQI (−9.4±10.0 p.p). The Clean Baseline demonstrated an opposite behavior (+9.1±7.9 p.p.). Beyond other factors, the major contribution for JARVIS behaving worst was systematic migration to negative answers (20 migration instances to a negative answer against 1 migration instance to an affirmative answer). Because the systems are different due to noise injection, the JARVIS behavior occurs due its output convergence to the marginal distribution of the training dataset (in this case, no) when it cannot encounter information to put pressure towards the correct polarity.

The strength of embodiments of the invention to ensure consistency of the model behavior (i.e., providing higher efficiency at lower complexity tasks (such as when SQI is introduced, therefore reducing the span of the output space).

The experiment also demonstrated that automated verification improves with respect to manual verification.

FIG. 5 discloses aspects of generating a curated dataset that includes variational QA pairs (each QA pair may include variational RPIs). In one example, a variational QA pair associates an SQI with an answer and acceptable or diversified variations of the answer. The method 500 illustrates an example of generating variational QA pairs from an original curated dataset of QA pairs. Generally, generating the variational QA pairs includes identifying unique SQIs (or unique SQI types) in the QA pairs. Each of the unique SQIs is then associated with a diversification strategy. The diversification strategy is configured to diversify the original cRPIs. Once the strategy is executed, the original cRPIs have essentially been converted to vRPIs. The vRPIs may be cleaned to remove redundancies and subject to a divergence check to remove, by way of example, ambiguities. The curated dataset of variational QA pairs may be used to evaluation or correctness measurements as previously described using QA pairs that include cRPIs.

FIG. 5 illustrates a method 500 that may start, in one example, from a curated dataset of QA pairs 502). In this example, SQI strategy guideline building 520 is performed to identify different types of SQIs included in the QA pairs 502.

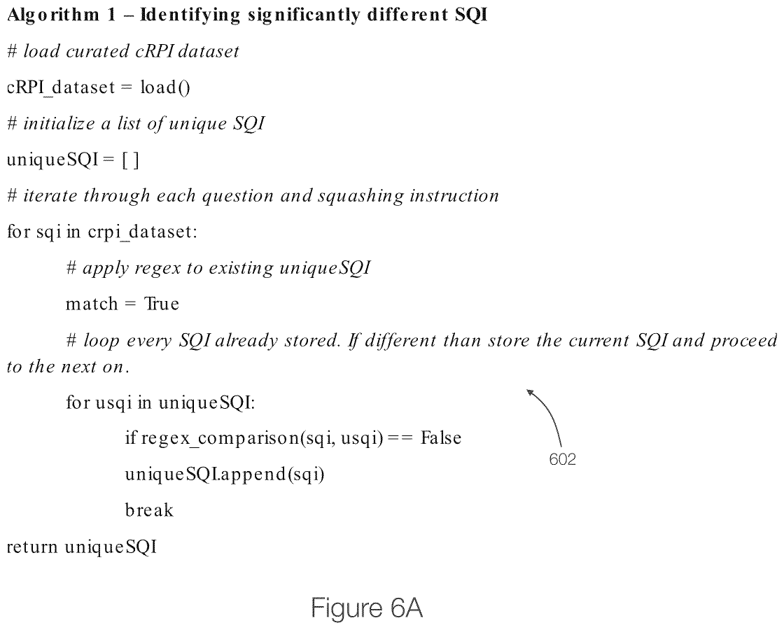

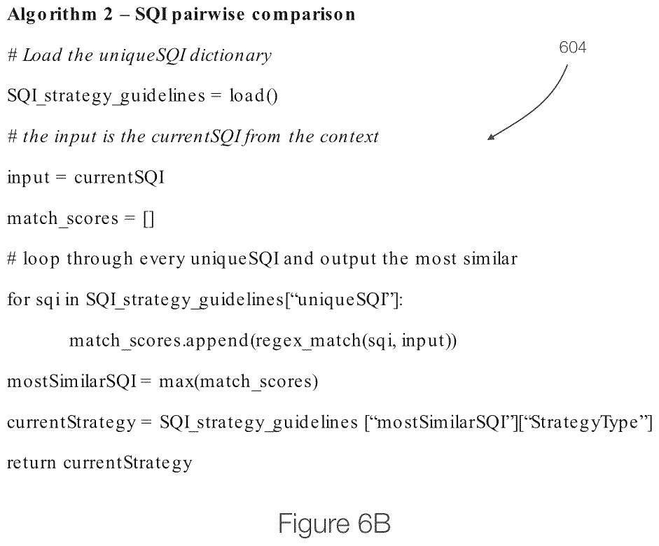

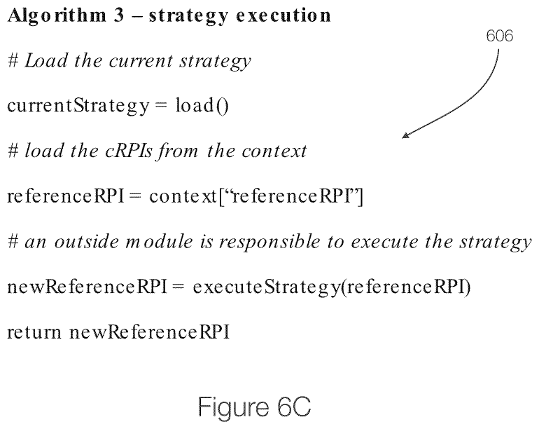

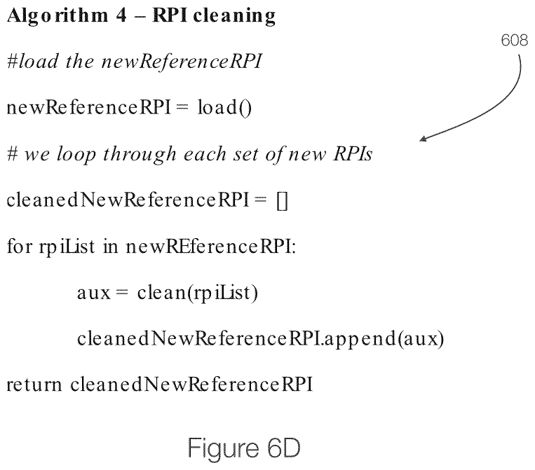

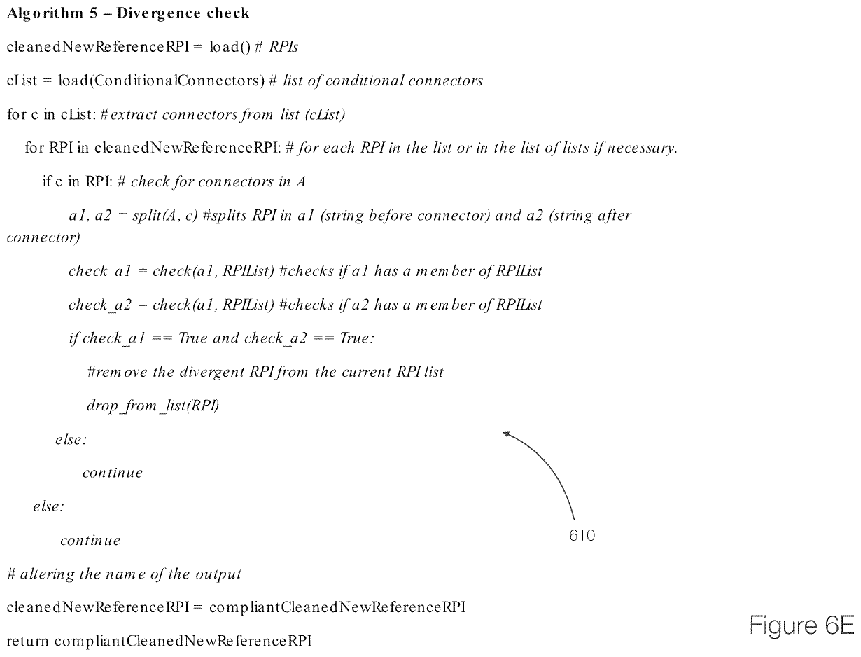

Initially, SQI strategy building 520 includes listing SQIs 522 found in the QA pairs 502, which is illustrated in FIG. 6A. FIG. 6A more specifically discloses aspects of listing unique SQIs in the QA pairs 502. FIG. 6A illustrates pseudocode or a method 602 for identifying unique (or significantly different) SQIs in the QA pairs 502. The method 602 generates an SQI listing. More specifically, the method 602 initializes an empty SQI list. Next, the method 602 loads the QA pairs 502 (or the SQIs included in the QA pairs 520) and loops through all of the SQIs. This allows unique SQIs to be identified and stored in a list as follows:
uniqueSQI=[uniqueSQI₁, uniqueSQI₂, . . . , uniqueSQIₙ].

In one example, this list identifies SQI types rather than specific SQIs. Thus, similar SQIs in the QA pairs 502 are all defined by or associated with at least one unique type in the list. In another example, unique SQIs are included in the list rather than unique SQI types.

After the unique SQIs have been identified from the dataset of QA pairs 502, strategy filling 524 is performed. Strategy filling 524 may be performed by a human in the loop or other user such as an SME. The user may define, for example, a diversification strategy for each of the unique SQI types at strategy filling 524. More specifically, strategy filling 524 may map single SQIs to a strategy. The strategy may be used to diversify the associated RPI. Example diversification strategies include LLM diversification, hard coded diversification, or custom defined diversification. A custom defined strategy may include defining transformation prompts to be employed by LLMs.

More specifically, strategy filling 524 allows each SQI type to be mapped to or associated with one or more diversification strategies. For example, an LLM may be used to diversify a cRPI to generate a vRPI.

SQI strategy guideline building 520 outputs SQI strategy guidelines, after generating 522 the SQI listing of unique SQI types and performing strategy filling for each of the unique SQI types, output strategy guidelines 526. For example, the output of strategy filling 524 (and an example of strategy guidelines) may be:

$$\begin{matrix}SQI - {strategy}_{guideline} = \{ unique {S QI}_{1} : StrategyA ; \\ {uniqueSQI}_{2} : strategyB , … , \\ unique {S QI}_{n} : strategyA \}\end{matrix}$$

The form of the strategy guidelines 526 can arbitrary. For example, different SQI types may benefit from the same strategy and each SQI type may be associated with one or more strategies.

The method 500 also includes context generation 504 on the QA pairs 502, which include curated RPIs. Context generation, includes generating properties for each of the QA pairs 502 as follows to form a context dictionary as follows:

$$context = \{ question : currentQuestion , sqi : currentSQI , referenceRPI : [ {cRPI}_{1} , {cRPI}_{2} , … , cRPIn ] \} .$$

As previously discussed and illustrated by the context, multiple cRPIs may exist or be present for the same QA pair as previously described. This occurs when more than one bit of information is expected to be available in the answer. Embodiments of the invention generate variations for each cRPI present in the context or in the QA pair being processed by the method 500.

Once the context 504 is generated, SQI type assessment is performed 506. FIG. 6B discloses aspects of SQI type assessment. The method 604 is configured to identify a most common unique SQI type for an input SQI identified in the context. More specifically, during this stage of the method 500, the context is obtained for a QA pair and the SQI of the QA pair (e.g., the currentSQI) is extracted. The method 604 loops through each unique SQI in the list of unique SQIs, which are represented in the strategy guidelines 526 to determine or identify an SQI type that is most similar to the current SQI of the QA pair. This may be done using a distance measurement. The strategy associated with the identified SQI type is retrieved from the SQI strategy guidelines 526.

Once the strategy is retrieved, the strategy is executed 508. FIG. 6C discloses pseudocode of a method 606 for executing the strategy. When executing the strategy or performing the method 606, a strategy component may retrieve a reference RPI. In this example, the reference RPI includes all of the cRPIs for the current QA pair or for the question in the QA pair. Each of the cRPIs is then diversified according to the strategy. The output of strategy execution 508 is a list of lists. More specifically, each cRPI may be replaced with a list of acceptable answers (variations). Stated differently, the QA pair now includes one or more vRPIs (one vRPI for each of the cRPIs that were in the original QA pair. Thus, each of the cRPIs in the original QA pair is diversified or varied according to a strategy.

Once the vRPIs have been generated, cleaning 510 is performed as illustrated in FIG. 6D. FIG. 6D discloses aspects of a method 608 for cleaning the vRPIs generated by executing the strategies on the cRPIs. The pseudocode thus illustrates a method 608, which is an example of cleaning 510. In this example of the method 608, the variational RPIs are compared in order to remove or exclude highly similar RPIs. This may be performed for each vRPI in the new variational QA pair. For example, a regex match or similarity measure such as Levenstein Distance may be performed. The output of the method 608 or cleaning 510, is a list of non-redundant variational RPIs or clean vRPIs (cleanedNewReferenceRPI in FIG. 6D.

After cleaning the vRPIs to generate clean vRPIs, a divergence check 512 is performed, as illustrated in FIG. 6E. More specifically, FIG. 6E discloses aspects of checking divergence in the clean vRPIs. The method 610, which is an example of a divergence check 512, relates to removing ambiguous RPIs that may have been inserted or generated earlier in the method 500. The method 610 may receive the clean vRPIs (e.g., cleanedNewReferenceRPI) and output a compliant or final vRPI. When the method 610 is completed and all of the clean vRPIs have been evaluated for all QA pairs, the output is accumulated and stored as final RPIs in the curated dataset of variational QA pairs 514. The variational QA pairs 514 form, in one example, a static dataset that can be used for automatic evaluation while dealing with low entropy variations in manifolds formed in the output space due to the use of SQIs.

In one example, the method 610 may depend on or use conditional connectors, such as [“but”, “maybe”, “perhaps”, “sometimes”, “however”]. In one example, identifying a divergence in a sequence with a conditional word list is based on finding: (i) an RPI followed by another RPI, and (ii) and a connector therebetween. This indicates a contradictory relationship between both bits of information. For example, sentences such as: “Yes maybe not” and “Yes PowerMax can, but PowerMax cannot” are examples of ambiguities. Finding this antagonistic relationship between both bits of information in a sentence is one goal of the method 610. In one example, this verification is done by looking at the regular expressions (regex) within the sentence.

In one example, cleaning 510 and the divergence check 512 rely on regex or adjustable similarity (distance-based) comparisons in making decisions. These similarity comparisons are used, in one example, because there is already one step introducing uncertainty to the pipeline (if LLM is used for diversification) and stacking uncertainty sources may not be convenient. In addition, this provides better explainability.

Thus, the method 500 generates a curated dataset of variational QA pairs that include final vRPIs from a curated dataset of QA pairs that singleton cRPIs.

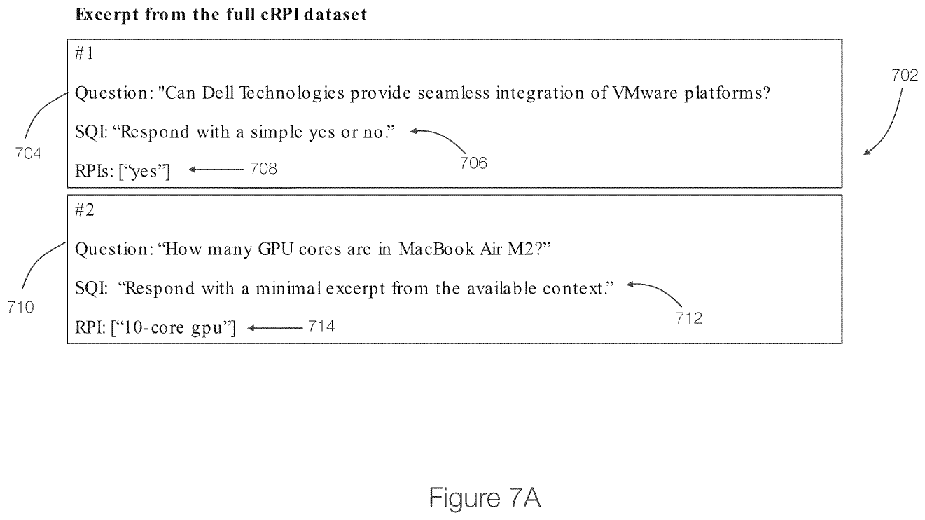

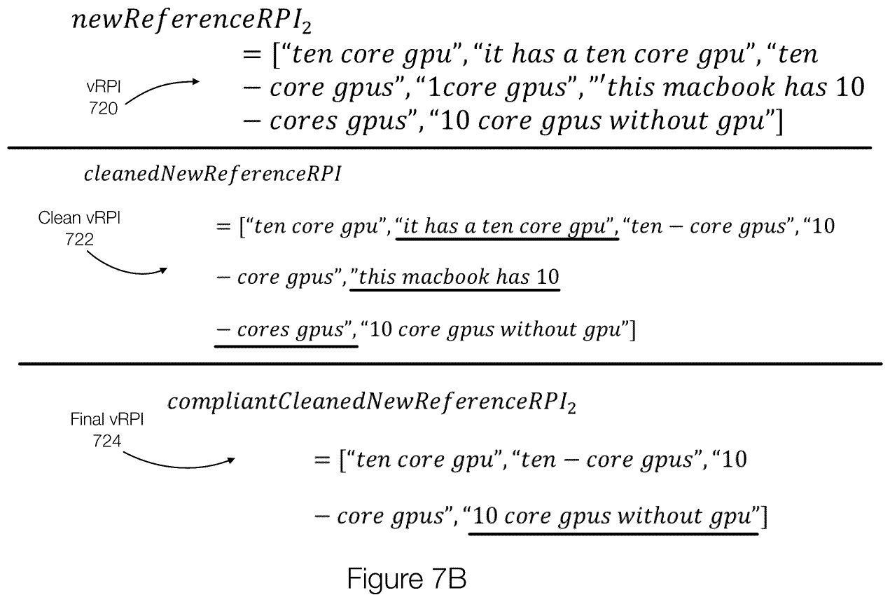

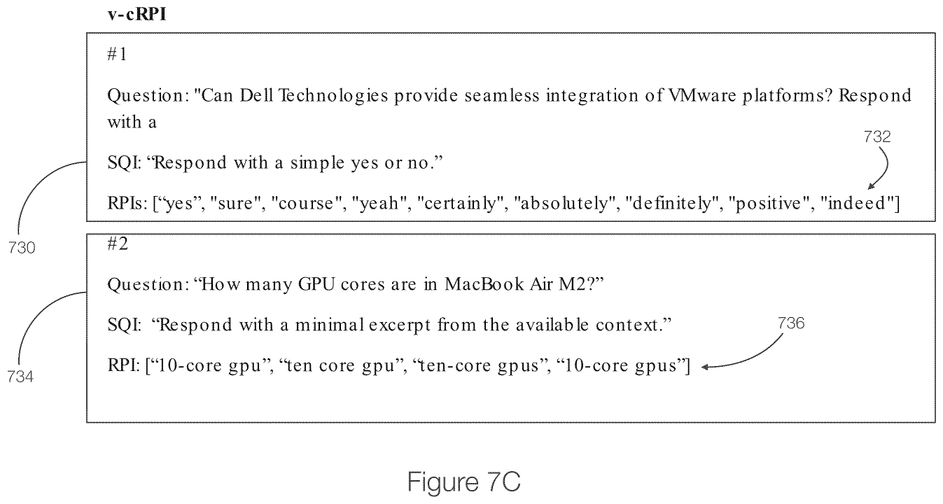

FIGS. 7A, 7B and 7C illustrate an example of diversifying a dataset of QA pairs or RPIs (cRPIs and/or aRPIs). In this example, aRPIs are not diversified. FIGS. 7A, 7B, and 7C are discussed with respect to the experiment previously described. FIG. 7A illustrates example QA pairs that each include an SQI from a curated dataset. In this example, the example QA pairs 702 include a QA pair 704 with an SQI 706 and a cRPI 708 and a QA pair 710 with an SQI 712 and a CRPI 714.

In this example, the RPIs 708 and 714 are diversified, in one example, by the method 500. The SQIs 706 and 712 are different SQIs in this example.

This example assumes that unique SQI types have been identified and that strategies have been associated to each of the unique SQI types. More specifically, after generating a list of unique SQIs from a curated dataset of QA pairs, a user (e.g., at 524) may be asked to provide strategies for each of the unique SQI types. In this example, the following strategy guidelines (e.g., at 526) are determined for SQI types represented by the SQIs 706 and 712:

$$SQI - {strategy}_{\{ guideline \}} = [ \{ Respond with a simple yes or no \} : Strategy B ; \{ Respond with a minimal excerpt from the available context \} : strategy A \} ] .$$

In this example, strategy A is a predetermined diversification strategy and strategy B is an LLM request. The LLM request may be a few-shot based approach.

Diversifying the RPI 708 for the QA pair 704 may proceed as follows. Initially, context generation 504 is performed and the SQI is assessed 506. RPI assessment 506 determines that the closest SQI type in the list of unique SQI types is “Respond with a simple yes or no” and that the strategy to be executed to diversify the RPI 708 is strategy A. Strategy execution 508, which is a predetermined strategy, is executed. In this example, strategy A is defined as follows:
Strategy A: “If YES, append [“sure”, “course”, “yeah”, “certainly”, “absolutely”, “definitely”, “positive”, “indeed”];
If NO, append [“not”, “never”, “any”, “none”, “negative”]”.

In the cleaning 510 and divergence check 512, redundancies and ambiguities are not removed. The diversified or final variational RPI is:

$${compliantCleanedNewReferenceRPI}_{1} = [ yes , sure , course , yeah , certainly , absolutely , definitely , positive , indeed ] .$$

FIG. 7C illustrates an example of the vRPI generated from the cRPI. In effect, the original QA pair 704 is converted to a variational QA pair 730 that includes a diversified or variational RPI 732.

FIG. 7C further illustrates that a diversified or vRPI 736 in the variational QA pair 734 is generated from the original cRPI 714 in the original QA pair 710. Thus, the QA pair 710 or more specifically the cRPI 714 is diversified in a similar manner to the diversification of the cRPI 8=708.

FIG. 7B discloses aspects of cleaning and performing a divergence check with respect to generating the vRPI 736 starting from the cRPI 714. In this example, the unique SQI is “Respond with a minimal excerpt from the text”, which is related to strategy B. In this example an LLM is tasked to generate alternatives to the cRPI 714. The output of the strategy B is illustrated as a vRPI 720. More specifically, because strategy B is LLM diversification, the output of the LLM is the vRPI 720.

FIG. 7B illustrates that cleaning 722 is performed on the vRPI 720 output by the LLM to generate a clean vRPI. As illustrated below, some of the RPIs included in the vRPI 720 are removed because they contain other RPIs. For example, “ten core gpu” is contained within “it has a ten core gpu”. Thus, the “it has a ten core gpu” RPI is removed during cleaning to. The removals are illustrated with underline in the clean vRPI 722.

Cleaning the vRPI 720 may be achieved, in one example, using a pair-wise regex comparison. The clean vRPI 722 is generated by the cleaning operation.

Although the clean vRPIs may include RPIs that appear similar from a human perspective, a regex operation may fail to detect this type of similarity. A performance check may identify and remove these types of issues, including ambiguities. In this example, the clean vRPI 722 includes an ambiguous RPI (“10 core gpus without gpu”) that is identified and removed during a divergence check 512. The output of the divergence check 512 for the RPI 706 is illustrated in FIG. 7B as final vRPI 724. The ambiguous RPI is illustrated with underline in the final vRPI 724.

After the cRPIs 708 and 714 (and other RPIs in the original QA dataset), FIG. 7C illustrates an example of a curated dataset of variational QA pairs that include variational RPIs. More specifically, once the method 500 is performed, the curated dataset of QA pairs 502 is converted to a dataset of variational QA pairs 514. Alternatively, the QA pairs 502 may be retained and stored separately from the variational QA pairs 514. Thus, once the diversification is completed, FIG. 7C illustrates that a variational RPI 732 generated from the RPI 708 and a variational RPI 736 generated from the RPI 714.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, automated verification operations, efficiency and/or correctness measurement operations, alignment operations, curation operations, cRPI and/or vRPI curation operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Synthetic documents and/or corresponding labels are examples of data or objects. An object may be a portion of a document image.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: for each question/answer (QA) pair in a curated dataset of QA pairs, wherein each of the QA pairs includes a question, a squashing instruction, and a referenced pattern of information (RPI), the RPIs including correct RPIs (CRPIs): assessing the squashing instruction to determine a diversification strategy for diversifying the RPI, and performing the diversification strategy on the RPI to generate a variational RPI (vRPI) from the RPI, storing the vRPIs generated from the RPIs in the curated dataset of QA pairs in a curated dataset of variational QA pairs, and performing automated verification in a generative system using the variational QA pairs.

Embodiment 2. The method of embodiment 1, further comprising generating a strategy guideline by creating a list of unique squashing instruction types from the squashing instructions included in the curated dataset of QA pairs and associating at least one diversification strategy with each of the unique squashing instruction types in the list.

Embodiment 3. The method of embodiment 1 and/or 2, further comprising assessing the squashing instruction to determine a most similar squashing instruction type in the list based on a distance measurement.

Embodiment 4. The method of embodiment 1, 2, and/or 3, wherein the diversification strategy is one of a large language model diversification strategy, a hard coded diversification strategy, or a custom-defined diversification strategy.

Embodiment 5. The method of embodiment 1, 2, 3, and/or 4, wherein the large language model diversification strategy diversifies the RPI by generating answer variations in response to a prompt, wherein a hard coded diversification strategy appends a pre-defined list of variational answers to the RPI, and wherein the custom-defined diversification strategy defines a transformation prompt.

Embodiment 6. The method of embodiment 1, 2, 3, 4, and/or 5, further comprising cleaning the variational RPI to generate a clean RPI, wherein cleaning the variational RPI includes excluding similar or redundant RPIs in the variational RPI based on a distance measurement.

Embodiment 7. The method of embodiment 1, 2, 3, 4, 5, and/or 6, further comprising performing a pair-wise comparison to identify similar or redundant RPIs.

Embodiment 8. The method of embodiment 1, 2, 3, 4, 5, 6, and/or 7, further comprising performing a performance check on the clean RPI to generate a final variational RPI.

Embodiment 9. The method of embodiment 1, 2, 3, 4, 5, 6, 7, and/or 8, wherein the performance check includes removing ambiguous RPIs.

Embodiment 10. The method of embodiment 1, 2, 3, 4, 5, 6, 7, 8, and/or 9, wherein ambiguous RPIs are identified by connectors that indicate a condition.

Embodiment 11. The method of embodiment 1, 2, 3, 4, 5, 6, 7, 8, 9, and/or 10, wherein the automated verification further comprises: for each variational QA pair: inputting a variational QA pair into the generative system, the variational QA pair including a question and a vRPI, evaluating an answer of the generative system in response to the question in the variational QA pair, generating a score for the variational QA pair based on a comparison of the answer generated by the generative system to the vRPI, and generating a cumulative score that includes scores for all of the variational QA pairs, wherein the cumulative score represents an alignment of the generative system to final user preferences.

Embodiment 12. The method of embodiment 1, 2, 3, 4, 5, 6, 7, 8, 9, 10, and/or 11, further comprising: determining information bits for the answer and setting a correctness bit for each vRPI associated with the variational QA pair found in the answer, setting an abstain bit when the answer represents abstaining, wherein the cumulative score is not penalized when the abstain bit is set; assigning a maximum penalty to the cumulative score when the abstain bit is not set and no correctness bits are set, and assigning a reward score to the cumulative score that is a ratio of a number of correctness bits set to total possible correctness bits for the answer.

Embodiment 13. The method of embodiment 1, 2, 3, 4, 5, 6, 7, 8, 9, 10, 11, and/or 12, further comprising generating the curated dataset of QA pairs by distilling knowledge of the generative system or from a source into the QA pairs, wherein each of the QA pairs includes a question, a squashing instruction, and an RPI, wherein the squashing instruction is configured to reduce a span of correct answers within an output space.

Embodiment 14. The method of embodiment 1, 2, 3, 4, 5, 6, 7, 8, 9, 10, 11, 12, and/or 13, further comprising performing a feedback loop on the QA pairs in the curated dataset of QA pairs, wherein the QA pairs are curated during the feedback loop, wherein the feedback loop includes a discard flow, a refinement flow, and an accept flow that are performed based on user feedback, wherein the variational QA pairs in the variational dataset of QA pairs are configured to align the generative system to final user preferences, wherein the generative system comprises a retrieval augmented generation (RAG) system.

Embodiment 15. A system, comprising hardware and/or software, operable to perform any of the operations, methods, or processes, or any portion of any of these, disclosed herein.

Embodiment 16. A non-transitory storage medium having stored therein instructions that are executable by one or more hardware processors to perform operations comprising the operations of any one or more of embodiments 1-14.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

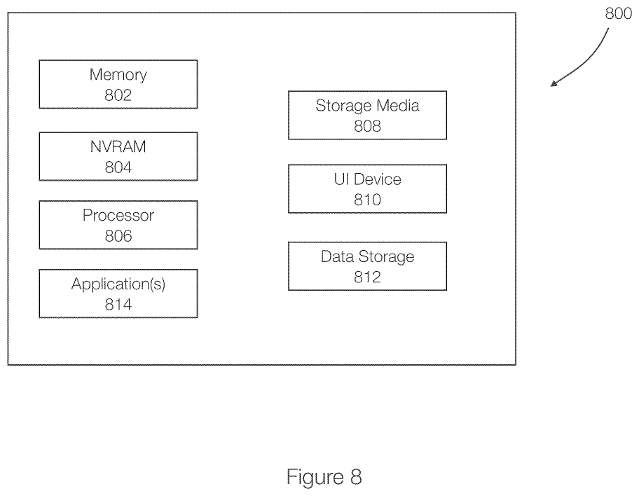

With reference briefly now to FIG. 8, any one or more of the entities disclosed, or implied, by the Figures and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid state device (SSD) storage. As well, one or more applications 814 may be provided that comprise instructions executable by one or more hardware processors 806 to perform any of the operations, or portions thereof, disclosed herein.

The device 800 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 800 may also represent a physical or virtual machine or server, an edge-based computing system, a cloud-based computing system, server clusters or other computing systems or environments. The device 800 may also represent multiple machines or devices, whether virtual, containerized, or physical. The device 800 may perform or execute steps or acts of the methods illustrated in the Figures.

The device 800 may represent a cloud-based system, an edge-based, system, an on-premise system, or combinations thereof. Curation operations, alignment operations, verification operations, user interface related operations, or the like may be performed using these types of computing environments/systems.

The described embodiments are to be considered in all respects only as illustrative and not restrictive. All changes which come within the meaning and range of equivalency of the claims are to be embraced within their scope.

What is claimed is:

1. A method comprising:
for each question/answer (QA) pair in a curated dataset of QA pairs, wherein each of the QA pairs includes a question, a squashing instruction, and a referenced pattern of information (RPI), the RPIs including correct RPIs (CRPIs):
assessing the squashing instruction to determine a diversification strategy for diversifying the RPI; and
performing the diversification strategy on the RPI to generate a variational RPI (vRPI) from the RPI;
storing the vRPIs generated from the RPIs in the curated dataset of QA pairs in a curated dataset of variational QA pairs; and
performing automated verification in a generative system using the variational QA pairs.

2. The method of claim 1, further comprising generating a strategy guideline by generating a list of unique squashing instruction types from the squashing instructions included in the curated dataset of QA pairs and associating at least one diversification strategy with each of the unique squashing instruction types in the list.

3. The method of claim 2, further comprising assessing the squashing instruction to determine a most similar squashing instruction type in the list based on a distance measurement.

4. The method of claim 3, wherein the diversification strategy is one of a large language model diversification strategy, a hard coded diversification strategy, or a custom-defined diversification strategy.

5. The method of claim 4, wherein the large language model diversification strategy diversifies the RPI by generating answer variations in response to a prompt, wherein a hard coded diversification strategy appends a pre-defined list of variational answers to the RPI, and wherein the custom-defined diversification strategy defines a transformation prompt.

6. The method of claim 3, further comprising cleaning the variational RPI to generate a clean RPI, wherein cleaning the variational RPI includes excluding similar or redundant RPIs in the variational RPI based on a distance measurement.

7. The method of claim 6, further comprising performing a pair-wise comparison to identify similar or redundant RPIs.

8. The method of claim 6, further comprising performing a performance check on the clean RPI to generate a final variational RPI.

9. The method of claim 8, wherein the performance check includes removing ambiguous RPIs.

10. The method of claim 9, wherein ambiguous RPIs are identified by connectors that indicate a condition.

11. The method of claim 1, wherein the automated verification further comprises:
for each variational QA pair:
inputting a variational QA pair into the generative system, the QA pair including a question and a vRPI;
evaluating an answer of the generative system in response to the question in the variational QA pair;
generating a score for the QA pair based on a comparison of the answer generated by the generative system to the vRPI; and
generating a cumulative score that includes scores for all of the variational QA pairs, wherein the cumulative score represents an alignment of the generative system to final user preferences.

12. The method of claim 11, further comprising:
determining information bits for the answer and setting a correctness bit for each vRPI associated with the variational QA pair found in the answer,
setting an abstain bit when the answer represents abstaining, wherein the cumulative score is not penalized when the abstain bit is set;
assigning a maximum penalty to the cumulative score when the abstain bit is not set and no correctness bits are set; and
assigning a reward score to the cumulative score that is a ratio of a number of correctness bits set to total possible correctness bits for the answer.

13. The method of claim 1, further comprising generating the curated dataset of QA pairs by distilling knowledge of the generative system or from a source into the QA pairs, wherein each of the QA pairs includes a question, a squashing instruction, and an RPI, wherein the squashing instruction is configured to reduce a span of correct answers within an output space.

14. The method of claim 13, further comprising performing a feedback loop on the QA pairs in the curated dataset of QA pairs, wherein the QA pairs are curated during the feedback loop, wherein the feedback loop includes a discard flow, a refinement flow, and an accept flow that are performed based on user feedback, wherein the variational QA pairs in the variational dataset of QA pairs are configured to align the generative system to final user preferences, wherein the generative system comprises a retrieval augmented generation (RAG) system.

15. A non-transitory storage medium having stored therein instructions that are executable by one or more hardware processors to perform operations comprising:
performing for each question/answer (QA) pair in a curated dataset of QA pairs, wherein each of the QA pairs includes a question, a squashing instruction, and an referenced pattern of information (RPI), the RPIs including correct RPIs (CRPIs):
assessing the squashing instruction to determine a diversification strategy for diversifying the RPI; and
performing the diversification strategy on the RPI to generate a variational RPI (vRPI) from the RPI;
storing the vRPIs generated from the RPIs in the curated dataset of QA pairs in a curated dataset of variational QA pairs; and
performing automated verification in a generative system using the variational QA pairs.

16. The non-transitory storage medium of claim 15, further comprising:
generating a strategy guideline by creating a list of unique squashing instruction types from the squashing instructions included in the curated dataset of QA pairs and associating at least one diversification strategy with each of the unique squashing instruction types in the list;
assessing the squashing instruction to determine a most similar squashing instruction type in the list based on a distance measurement.

17. The non-transitory storage medium of claim 16, wherein the diversification strategy is one of a large language model diversification strategy, a hard coded diversification strategy, or a custom-defined diversification strategy, wherein the large language model diversification strategy diversifies the RPI by generating answer variations in response to a prompt, wherein a hard coded diversification strategy appends a pre-defined list of variational answers to the RPI, and wherein the custom-defined diversification strategy defines a transformation prompt.

18. The non-transitory storage medium of claim 15, further comprising cleaning the variational RPI to generate a clean RPI, wherein cleaning the variational RPI includes excluding similar or redundant RPIs in the variational RPI based on a distance measurement and performing a performance check on the clean RPI to generate a final variational RPI, wherein the performance check includes removing ambiguous RPIs.

19. The non-transitory storage medium of claim 18, wherein ambiguous RPIs are identified by connectors that indicate a condition.

20. The non-transitory storage medium of claim 15, wherein the automated verification further comprises:
for each variational QA pair:
inputting a variational QA pair into a generative system, the QA pair including a question and a vRPI;
evaluating an answer of the generative system in response to the question in the QA pair; and
generating a score for the QA pair based on a comparison of the answer generated by the generative system to the vRPI;
generating a cumulative score that includes scores for all of the QA pairs in the variational QA pairs, wherein the cumulative score represents an alignment of the generative system to final user preferences.
